(19) United States
(12) Patent Application Publication
(10) Pub. No.: US 2024/0282103 A1
(43) Pub. Date: Aug. 22, 2024

(54) DATA UPDATING METHOD, MODEL TRAINING METHOD, APPARATUS, ELECTRONIC DEVICE AND MEDIUM

(71) Applicant: Beijing Baidu Netcom Science Technology Co., Ltd., Beijing (CN)

(72) Inventors: Congxi XIAO, Beijing (CN); Jizhou HUANG, Beijing (CN); Jingbo ZHOU, Beijing (CN)

(73) Assignee: Beijing Baidu Netcom Science Technology Co., Ltd., Beijing (CN)

(21) Appl. No.: 18/654,477

(22) Filed: May 3, 2024

(30) Foreign Application Priority Data
May 6, 2023 (CN) 202310506727.6

(51) Int. Cl. G06V 20/10; G06V 10/26; G06V 10/74; G06V 10/82

(52) U.S. Cl. CPC G06V 20/176; G06V 10/26; G06V 10/761; G06V 10/82

(57) ABSTRACT

A data updating method, a model training method and related devices are provided. The method includes obtaining urban graph data in a preset region, the urban graph data including a node set including central nodes, an edge set and a feature set, the edge set including neighborhoods corresponding to the central nodes, the neighborhoods including other nodes possessing connecting edges with the central nodes, the neighborhoods corresponding to a target region, and the feature set including node features of the nodes in the node set; partitioning the target region into at least two sub-regions to obtain a region partition set; aggregating the node features corresponding to all nodes located within the same sub-region to obtain the regional features of each of the sub-regions; updating the node features of the central node based on the regional features of the sub-regions in the region partition set to obtain target feature data.

### CROSS-REFERENCE TO RELATED APPLICATION

The present disclosure claims a priority of the Chinese patent application No. 202310506727.6 filed in China on May 6, 2023, which is incorporated herein by reference in its entirety.

### TECHNICAL FIELD

The present disclosure relates to the field of data processing technology, in particular to the technical fields of deep learning, smart cities, and urban governance. Specifically, the present disclosure relates to a data updating method, a model training method, apparatus, electronic device and medium.

### BACKGROUND

With the continuous acceleration of the global urbanization process, the scale of cities continues to grow. In order to achieve long-term development of cities, smart cities gradually emerge. Urban intelligent computing is of great significance for improving the level of urban governance, improving the quality of public services, and developing the digital economy. In urban intelligent computing, relevant technologies propose that cities can be modeled and various urban entities (such as regions, points of interest, roads, etc.) can be represented and transformed into computable vector representations. In this way, the computation process of urban intelligent computing can be simplified.

### SUMMARY

The present disclosure provides a data updating method, model training method, apparatus, electronic device, and medium.

According to a first aspect of the present disclosure, a data updating method is provided, including:
partitioning a target region into at least two sub-regions to obtain a region partition set, where the target region corresponds to a neighborhood of a central node, the neighborhood includes other nodes possessing a connecting edge to the central node, and preset urban entities corresponding to the nodes in the neighborhood are located within the target region;
generating regional features for each of the sub-regions based on node features of the nodes in the neighborhood;
generating a relation set based on the regional features of the sub-regions in the region partition set, the relation set including at least two pieces of relation information corresponding one-to-one with the at least two sub-regions, and the relation information being used to represent the relation information between the corresponding sub-region and other sub-regions;
updating the node features of the central node based on the relation set and the regional features of the sub-regions in the region partition set to obtain target feature data.

According to a second aspect of the present disclosure, a model training method is provided, including:
obtaining urban graph data, the urban graph data including a node set, an edge set, and a feature set, the node set including central nodes corresponding to preset urban entities in the preset region, the edge set including neighborhoods corresponding to the central nodes, the neighborhoods including other nodes in the node set possessing connecting edges with the central nodes, the feature set including node features of the central nodes, the neighborhoods corresponding to a target region in the preset region, and the preset urban entities corresponding to the nodes in the neighborhood are located within the target region;
updating the node features of each of the central nodes in the feature set based on the data updating method according to the foregoing first aspect to obtain a target feature set, and the target feature set including target feature data of each node in the node set;
training a pre-constructed initial urban index generation model based on the node set, the edge set and the target feature set to obtain a target model, wherein the target model is used to generate score values of preset urban indices, and wherein the preset urban indices are urban indices associated with the preset urban entities.

According to a third aspect of the present disclosure, a data updating apparatus is provided, including:
a partition module configured to partition a target region into at least two sub-regions to obtain a region partition set, wherein the target region corresponds to a neighborhood of a central node, the neighborhood includes other nodes possessing a connecting edge to the central node, and preset urban entities corresponding to the nodes in the neighborhood are located within the target region;
a first generation module configured to generate regional features for each of the sub-regions based on node features of the nodes in the neighborhood;
a second generation module configured to generate a relation set based on the regional features of the sub-regions in the region partition set, the relation set including at least two pieces of relation information corresponding one-to-one with the at least two sub-regions, and the relation information being used to represent the relation information between the corresponding sub-region and other sub-regions;
a first updating module configured to update the node features of the central node based on the relation set and the regional features of the sub-regions in the region partition set to obtain target feature data.

According to a fourth aspect of the present disclosure, a model training apparatus is provided, including:
an obtaining module configured to obtain urban graph data, the urban graph data including a node set, an edge set, and a feature set, the node set including central nodes corresponding to preset urban entities in the preset region, the edge set including neighborhoods corresponding to the central nodes, the neighborhoods including other nodes in the node set possessing connecting edges with the central nodes, the feature set including node features of the central nodes, the neighborhoods corresponding to a target region in the preset region, and the preset urban entities corresponding to the nodes in the neighborhood are located within the target region;
a second updating module configured to update the node features of each of the central nodes in the feature set based on the data updating method according to the foregoing first aspect to obtain a target feature set, and the target feature set including target feature data of each node in the node set;
a training module configured to train a pre-constructed initial urban index generation model based on the node set, the edge set and the target feature set to obtain a target model, wherein the target model is used to generate score values of preset urban indices, and wherein the preset urban indices are urban indices associated with the preset urban entities.

According to a fifth aspect of the present disclosure, an electronic device is provided, including:
at least one processor; and
a memory communicatively connected to the at least one processor,
wherein the storage stores therein an instruction configured to be executed by the at least one processor, and the at least one processor is configured to execute the instruction, to implement the method according to the foregoing first aspect or second aspect.

According to a sixth aspect of the present disclosure, a non-transitory computer readable storage medium storing therein a computer instruction is provided, wherein the computer instruction is configured to be executed by a computer, to implement the method according to the foregoing first aspect or second aspect.

According to a seventh aspect of the present disclosure, a computer program product is provided, including a computer program, wherein the computer program is configured to be executed by a processor, to implement the method according to the foregoing first aspect or second aspect.

In embodiments of the present disclosure, a target region is partitioned into at least two sub-regions and regional features for each of the sub-regions are generated based on node features. Then relation information between different sub-regions is generated based on the regional features of the sub-regions and the node features of the central node are updated based on the relation information and the regional features of the sub-regions to obtain target feature data. In this way, on the one hand, the problem of poor quality of the generated target feature data due to spatial heterophily in urban graph data during the process of updating the node features of the central node can be alleviated. On the other hand, the present disclosure aggregates the features of nodes at different spatial positions separately, thereby ensuring that spatial information of urban entities is fully considered in the process of generating the target feature data, so as to mine the semantic differences brought by different spatial relations under the same topological structure, and thereby improving the quality of the generated target feature data.

### BRIEF DESCRIPTION OF THE DRAWINGS

The drawings are used for better understanding the present solution and do not constitute a limitation of the present disclosure. In the drawings:

FIG. 1 is a first flow chart of a data updating method according to an embodiment of the present disclosure;

FIG. 2 is a schematic diagram of sub-regions obtained after partitioning a target region in an embodiment of the present disclosure;

FIG. 3 is a second flow chart of a data updating method according to an embodiment of the present disclosure;

FIG. 4 is a flow chart of a model training method according to an embodiment of the present disclosure;

FIG. 5 is a structural diagram of a data updating apparatus according to an embodiment of the present disclosure;

FIG. 6 is a structural diagram of a first updating module according to an embodiment of the present disclosure;

FIG. 7 is a structural diagram of an updating submodule according to an embodiment of the present disclosure;

FIG. 8 is a structural diagram of a model training apparatus according to an embodiment of the present disclosure;

FIG. 9 is a block diagram of an electronic device configured to implement a data updating method and a model training method according to an embodiment of the present disclosure;

FIG. 10 is an enlarged view of a lower portion of FIG. 3;

FIG. 11 is an enlarged view of a middle portion of FIG. 3; and

FIG. 12 is an enlarged view of an upper portion of FIG. 3.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

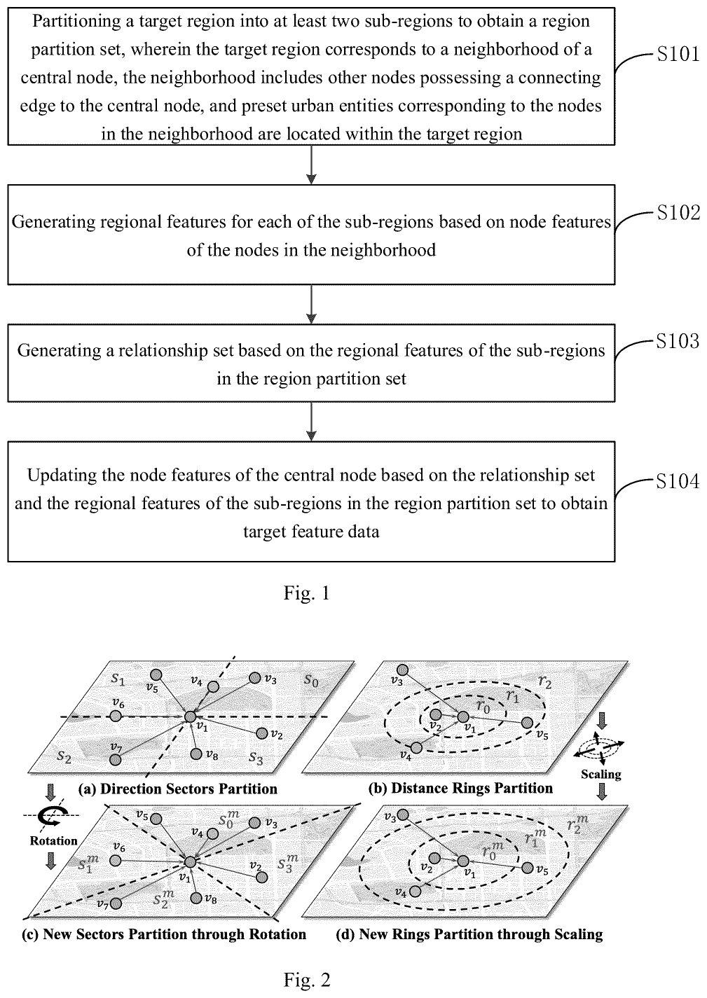

Referring to FIG. 1, FIG. 1 is a flow chart of a data updating method according to an embodiment of the present disclosure and the data updating method includes the following steps:

Step S101: partitioning a target region into at least two sub-regions to obtain a region partition set, where the target region corresponds to a neighborhood of a central node, the neighborhood includes other nodes possessing a connecting edge to the central node, and preset urban entities corresponding to the nodes in the neighborhood are located within the target region.

Step S102: generating regional features for each of the sub-regions based on node features of the nodes in the neighborhood.

Step S103: generating a relation set based on the regional features of the sub-regions in the region partition set, where the relation set includes at least two pieces of relation information corresponding with the at least two sub-regions in a one-to-one manner, and the relation information is used to represent relation information between the corresponding sub-region and other sub-regions.

Step S104: updating the node features of the central node based on the relation set and the regional features of the sub-regions in the region partition set to obtain target feature data.

A city is an extremely complex system, in which various urban entities are interconnected in various ways (for example, human flow between regions, road connecting relation, etc.), and considering these relations plays an important role in learning the representation of urban entities. Therefore, a city can be modeled as an urban graph, where nodes on the graph represent certain urban entities, edges on the graph represent some kind of association between entities, and graph neural networks (GNNs) are used to learn from the urban graph and capture relations between urban entities to learn more effective representations of urban entities.

However, unlike general graphs, urban graphs usually have spatial heterophily, which greatly limits the performance of general graph neural networks. Heterophily and homophily of graphs are two relative concepts. General GNN models assume that graph data has good homophily, that is, nodes with similar features or the same category are connected together, and good homophily is considered to be the performance guarantee of GNN models. However, due to the complex associations between urban entities with different functions, urban graphs often have heterophily, that is, connected nodes may be dissimilar. For example, considering the population mobility graph between regions, there is often a human flow relation between residential regions and workplaces, but obviously there are huge differences between these two types of regions. For graphs with heterophily, general GNN models smooth the representation of dissimilar nodes, making it impossible to correctly distinguish them.

Further, the neighbor heterophily of urban graphs often presents a certain spatial diversity, which can be specifically referred to as spatial heterophily. Specifically, in an urban graph, there is dissimilarity between the central node and its neighbor nodes, and the dissimilarity distribution between neighbor nodes at different geographical locations and the central node is different and not uniform, that is, there is spatial diversity in the dissimilarity.

Based on this, the present disclosure proposes that in the representation learning of urban graphs, the neighbor nodes of the central node can be grouped (i.e., partitioned into different sub-regions) according to the spatial position, which makes the neighbors within the group have similar dissimilarity distribution with the central node. In this way, the diversity of neighbor heterophily within the group can be alleviated, and then a heterophily graph learning algorithm can be designed to deal with each group separately, and solve the spatial heterophily of urban graphs by dividing and conquering. At the same time, by obtaining the relation set, and updating the node features of the central node based on the relation set, the relation information in the relation set can better learn distinguishable representations for related but dissimilar urban entities. Then, the problem of poor quality of the target feature data generated in the process of updating the node features of the central node due to the spatial heterophily of urban graph data can be further alleviated.

It can be understood that before the foregoing step of partitioning the target region into at least two sub-regions to obtain the region partition set, the data updating method may further include the following steps:

obtaining urban graph data in the preset region, the urban graph data including a node set, an edge set and a feature set, the node set including central nodes corresponding to preset urban entities in the preset region, the edge set including neighborhoods corresponding to the central nodes, the neighborhoods including other nodes in the node set possessing connecting edges with the central nodes, the neighborhoods corresponding to a target region in the preset region, and preset urban entities corresponding to the nodes in the neighborhood being located within the target region, and the feature set including node features of the nodes in the node set.

Specifically, the foregoing preset region can be a large spatial range, wherein various urban entities exist in the preset region. Specific urban entities in the preset region can be selected according to the specific scenario to construct the foregoing node set, and then the edge set is constructed according to the relations of the nodes in the node set, and the feature set is constructed by obtaining the relevant features of the urban entities corresponding to each node. For example, in the prosperity prediction scenario, when a prediction model for urban prosperity needs to be trained, different nodes in the node set corresponding to preset urban entities can be different regions within the preset region, and then different nodes can be connected by connecting edges according to human flow to generate the edge set. Specifically, when the number of floating population between two nodes exceeds a preset value, a connecting edge is established between the two nodes. Correspondingly, when the number of floating population between two nodes does not exceed the preset value, no connecting edge is established between the two nodes. Then, each node is taken as a central node, and other nodes possessing connecting edges with the central node are determined to generate a neighborhood corresponding to each central node. It can be understood that each node in the node set can be a central node or another node connected to other central nodes. In this way, the edge set is generated, which includes a neighborhood corresponding to each node in the node set. Finally, relevant features of each node are analyzed separately to obtain node features of each node, thereby generating the feature set. Specifically, the node features can include features that reflect urban prosperity, such as the number of entertainment venues, malls, hospitals and universities in the urban region corresponding to the node. After obtaining the foregoing features of each node, the feature set can be obtained.

For example, when it is necessary to predict the human flow relation between regions, the foregoing urban graph data can be population mobility graph data. Specifically, regions can be taken as nodes, i.e., the preset urban entities corresponding to the nodes are regions, and connecting edges according to the human flow relation between regions are established, and the node features can be regional features of different regions. Accordingly, when it is necessary to identify dangerous road sections, the urban graph data can be road network graph data, in which case intersections can be taken as nodes, connecting edges can be established according to the connecting relation of roads, and the node features can be road section features of different road sections in the road network, such as road section length, real-time vehicle traffic data, etc.

The following further explains the data updating method with reference to the foregoing prosperity prediction scenario. Specifically, the node features of each node in the urban graph data can be updated based on the method of embodiments of the present disclosure, and the urban graph data with updated node features can be used to train a pre-constructed model, so as to train a model that can predict urban prosperity based on the urban graph data. That is, the foregoing data updating method can be used to generate training data for the prosperity prediction model.

Specifically, the preset region can be partitioned into multiple small regions according to the partition method of administrative regions in the related technology, and each small region can be used as a node in the prosperity prediction scenario to obtain the node set. The foregoing central node is any one of the nodes in the node set. The present disclosure takes updating the node features of a central node based on the data updating method as an example, and explains the specific implementation process of the data updating method. G=(V, E, X) can be used to represent the foregoing urban graph data. V={v₁, v₂, . . . , v_{N}} represents the node set composed of preset urban entities within the preset region, E represents the edge set defined by some relation between urban entities (for example, the relation can be based on the number of floating population between the nodes), [symbol] (vᵢ)={vⱼ|(vᵢ, vⱼ)ϵE} represents the neighborhood of node vᵢ. XϵR^{N×d} represents the node feature matrix, wherein the i-th row represents the d-dimensional feature vector of node vᵢ, that is, the i-th row is the node feature of node vᵢ, and the d-dimensional vector can be constructed based on features that can reflect urban prosperity, such as the number of entertainment venues, malls, hospitals and universities in the region corresponding to node vᵢ. It can be understood that in different tasks, the node set V and edge set E can represent different urban entities and relations.

Since the foregoing node set includes a large number of nodes, and other nodes possessing a connecting edge with the foregoing central node may only be part of the nodes in the node set. And different nodes in the neighborhood corresponding to the central node are distributed in different locations in the preset region, therefore, a target region can be determined according to the location of the central node and the locations of the nodes in the neighborhood corresponding to the central node, wherein the central node and the nodes in the neighborhood are both located within the target region. It can be understood that the target region is a part of the preset region.

The foregoing partitioning the target region into at least two sub-regions can be specifically performed according to a direction-aware partition method for the target region. Specifically, for a certain central node vᵢ, the target region centered on vᵢ can be equally partitioned into a series of sectors [symbol] ={sₖ|k=0, 1, . . . , nₛ−1}, wherein nₛ represents the number of sectors obtained by the partition. Correspondingly, the neighbor nodes in the neighborhood [symbol] (vᵢ) can be assigned to different sectors, and the neighbor nodes distributed in different sectors can be redefined as different direction-aware neighborhoods { [symbol] (vᵢ)|k=0, 1, . . . , nₛ−1}, and satisfy

$${⋃}_{k = 0}^{{n}_{s} - 1} {𝒩}_{{s}_{k}} ( {v}_{i} ) = 𝒩 ( {v}_{i} ) .$$

Under such a partition, different direction-aware neighborhoods (sectors) can be regarded as different sub-regions, representing different relative spatial relation between the neighbor nodes and the central node. FIG. 2(a) shows an example of direction-aware partition with the central node as v₁. Since the node features of the nodes in each sub-region are aggregated separately after the region partition, at least two regional features corresponding one-to-one with the at least two sub-regions can be obtained, and the different regional features in the at least two regional features represent the features of the neighbor nodes in different directions of the central node. Therefore, compared with directly aggregating the node features of all nodes in the neighborhood corresponding to the central node, the present disclosure uses the regional features of the sub-regions in the region partition set to update the node features of the central node to obtain target feature data, which can preserve the direction features of each neighbor node in the domain and is conductive to mine the semantic differences brought by different spatial relations under the same topology structure, and thereby improving the quality of the generated target feature data.

In addition, since the relative position relation between urban entities not only includes different directions, but also different distances. Therefore, in another embodiment of the present disclosure, the target region can also be partitioned according to a distance-aware partitioning method. Specifically, as shown in FIG. 2(b), this embodiment partitions the target region corresponding to the neighborhood along the distance view. Specifically, a distance segment can be defined first, such as [<2.5 km, 2.5-5 km, >2.5 km]. According to this distance section, the target region centered on vᵢ can be partitioned into a series of rings [symbol] ={rₖ|k=0, 1, . . . , nᵣ−1}, wherein nᵣ represents the number of rings. Similarly, the neighborhood [symbol] (vᵢ) of vᵢ can be partitioned into a series of distance-aware neighborhoods { [symbol] (vᵢ)|k=0, 1, . . . , nᵣ−1}, and satisfies

$${⋃}_{k = 0}^{{n}_{r} - 1} {𝒩}_{{r}_{k}} ( {v}_{i} ) = 𝒩 ( {v}_{i} ) .$$

Since after performing region partitioning, the node features of the nodes in each sub-region are aggregated separately, thus, at least two regional features corresponding one-to-one with the at least two sub-regions can be obtained, and different regional features in the at least two regional features represent the features of the neighbor nodes at different distances from the central node. Therefore, compared with directly aggregating the node features of all nodes in the neighborhood corresponding to the central node, the present disclosure uses the regional features of the sub-regions in the region partition set to update the node features of the central node to obtain target feature data, which retain the distance features of each neighbor node in the neighborhood and is conductive to mine the semantic differences brought by different spatial relations under the same topology structure, and thereby improving the quality of the generated target feature data.

The foregoing generating the regional features for each of the sub-regions based on the node features of the nodes in the neighborhood can specifically refer to: generating the regional features of each sub-region based on the node features of the nodes within each sub-region, and the specific generation process can adopt the feature fusion method in the related technology to generate the regional features based on the node features.

The foregoing generating the relation set based on the regional features of the sub-regions in the region partition set can specifically refer to: determining the feature relation information between the regional features of each sub-region and other sub-regions respectively to obtain the relation information corresponding to each sub-region, wherein, the feature relation information can refer to the similarity degree or difference degree between features and other relation information.

The foregoing updating the node features of the central node based on the relation set and the regional features of the sub-regions in the region partition set can specifically refer to: fusing the regional features of the sub-regions in the region partition set with the node features of the central node, and incorporating the relation information between different sub-regions in the fusion process, to obtain the target feature data.

In this embodiment, a target region is partitioned into at least two sub-regions and regional features for each of the sub-regions are generated based on node features. Then relation information between different sub-regions is generated based on the regional features of the sub-regions and the node features of the central node are updated based on the relation information and the regional features of the sub-regions to obtain target feature data. In this way, on the one hand, the problem of poor quality of the generated target feature data due to spatial heterophily in urban graph data during the process of updating the node features of the central node can be alleviated. On the other hand, the present disclosure aggregates the features of nodes at different spatial positions separately, thereby ensuring that spatial information of urban entities is fully considered in the process of generating the target feature data, so as to mine the semantic differences brought by different spatial relations under the same topological structure, and thereby improving the quality of the generated target feature data.

Optionally, the relation information includes common information and difference information, the common information is used to represent the shared information between the corresponding sub-region and other sub-regions, and the difference information is used to represent the difference information between the corresponding sub-region and other sub-regions.

When performing region partitioning centered on the central node, the central node is usually not in any one of the at least two sub-regions, in this case, the central node can be separately regarded as a central sub-region, and the region partition set includes the central sub-region. In this way, when calculating the relation information, not only can the relation information between different sub-regions (spatial group-spatial group) be calculated, but also the relation information between each sub-region and the central sub-region (central node-spatial group) can be calculated.

The foregoing common information can specifically refer to the common knowledge or similar characteristics between the regional features of different sub-regions, which can be used to enhance the representation of each sub-region (including the central node). Correspondingly, in addition to the common knowledge, modeling the difference information of the neighboring nodes is crucial for urban graphs with heterophily. Therefore, in embodiments of the present disclosure, the relation information also includes difference information, wherein the difference information refers to the differences or dissimilarities between different sub-regions. In this way, it is conductive to improve the relation expression effect of the relation information between different sub-regions.

Specifically, when generating the common information, the similarity between the regional features of each sub-region and the regional features of other sub-regions can be calculated respectively, and then the common information corresponding to each sub-region can be determined based on the feature similarity between each sub-region and other sub-regions. Correspondingly, when generating the difference information, the difference degree between the regional features of each sub-region and the regional features of other sub-regions can be calculated respectively, and then the difference information corresponding to each sub-region can be determined based on the feature difference degree between each sub-region and other sub-regions.

In this embodiment, compared with the general graph neural network (homophily graph neural network), the method according to the present disclosure can consider both the commonality and the difference of the urban entities associated on the urban graph, and use the difference information to better learn distinguishable representations for the associated but dissimilar urban entities.

Optionally, the updating the node features of the central node based on the relation set and the regional features of the sub-regions in the region partition set to obtain the target feature data includes:
updating the regional features of each of the sub-regions based on the relation set to obtain target regional features of each of the sub-regions;
updating the node features of the central node based on the target regional features of the sub-regions in the region partition set to obtain the target feature data.

Specifically, since the relation information corresponding to each sub-region can also be regarded as another view of regional features of the sub-region, therefore, after generating regional features of the sub-region based on node features of nodes in each sub-region, the regional features of the sub-region can be further fused with the relation information corresponding to the sub-region to obtain target regional features of that sub-region.

In this embodiment, since the target regional features not only fuse node features of nodes within the sub-region, but also fuse relation information with other sub-regions, therefore, it is conductive to improve the feature expression effect of the sub-region, and thereby being conductive to improve the quality of target feature data generated based on target regional features.

Optionally, the partitioning the target region into at least two sub-regions to obtain the region partition set includes:
performing an M-fold region partition on the target region based on a target partition method to obtain the region partition set, the region partition set including M region partition subsets corresponding one-to-one with the M-fold region partition, each of the region partition subsets including at least two sub-regions, different fold partitions in the M-fold region partition corresponding to different partition parameters, the M being an integer greater than 1, and the partition parameters including at least one of the following: position parameters of partitioning lines in the target region and distance parameters between the different partitioning lines.

The foregoing partitioning lines are boundary lines between adjacent sub-regions, that is, the partitioning lines are partitioning lines that separate adjacent sub-regions.

Specifically, considering some special cases: some neighbor nodes in the foregoing neighborhood are distributed on the boundary of two sub-regions and cannot be determined to belong to which sub-region; for example, for the sector partition in FIG. 2(a), node v₆ is distributed on the boundary of sectors s₀ and s₁, indicating that this single sector partition is not sufficient to fully describe diverse spatial relations. A similar phenomenon also occurs in distance ring partition, such as node v₄ in FIG. 2(b). Therefore, the present disclosure further proposes a rotation-scaling multi-head partition strategy, which performs multiple partitions in both direction and distance views, so that different partitions can complement each other. The present disclosure introduces two operations, namely sector rotation and ring scaling, to achieve multiple spatial partitions and model diverse spatial relations. Specifically, as shown in FIG. 2(a) and FIG. 2(c), another set of sector partitions can be obtained by rotating the boundary of the sector by an angle (such as 45 degrees), and then neighbor nodes can be re-assigned to newly partitioned sectors to form a new set of direction-aware neighborhoods. After introducing this multiple partitioning, by updating the formal expression of the sector to [symbol] ={sₖ^{m}|k=0, 1, . . . , nₛ−1}, updating the representation of direction-aware neighborhood to

$$\{ {𝒩}_{{s}_{k}^{m}} ( {v}_{i} ) \vert k = 0 , 1 , … , {n}_{s} - 1 \} ,$$

wherein m=1, 2, . . . , Mₛ, Mₛ represents the number of partitions, that is, Mₛ-fold partitions are performed.

It can be understood that the foregoing

$$\{ {𝒩}_{{s}_{k}^{m}} ( {v}_{i} ) \vert k = 0 , 1 , … , {n}_{s} - 1 \}$$

includes Mₛ-fold partition results and all sub-regions obtained by Mₛ-fold partitions can be regarded as sub-regions in the region partition set. In this way, node features can be aggregated once based on each fold partition result respectively, and then regional features of sub-regions in each fold partition result in Mₛ-fold partition results can be obtained, and node features of the central node can be updated based on regional features of sub-regions in each fold partition result in Mₛ-fold partition results.

Similarly, in distance view, as shown in FIG. 2(b) and FIG. 2(d), new partitions can be obtained by scaling the boundary of the ring. The formal expressions of each ring and distance-aware neighborhood are also updated to [symbol] ={rₖ^{m}|k=0, 1, . . . , nᵣ−1} and

$$\{ {𝒩}_{{r}_{k}^{m}} ( {v}_{i} ) \vert k = 0 , 1 , … , {n}_{r} - 1 \} ,$$

wherein m=1, 2, . . . , Mᵣ. In this way, different groups of spatial partitions can complementarily represent geographic location distribution of neighbors and solve the problems that single partition is not comprehensive or accurate enough. In spatial partitioning, since central node vᵢ itself does not belong to any sector or ring, therefore vᵢ can be regarded as an additional spatial grouping, i.e.,

$${𝒩}_{{s}_{{n}_{s}}^{m}} ( {v}_{i} ) = {𝒩}_{{r}_{{n}_{r}}^{m}} ( {v}_{i} ) = \{ {v}_{i} \} .$$

In this embodiment, by performing an M-fold region partition on the target region based on a target partition method to obtain a region partition set, it makes different partitions complement each other, thereby improving effect of region partition.

Optionally, the target partition method includes a first sub-partition method and a second sub-partition method, and performing an i-th fold partition in the M-fold region partition on the target region based on the target partition method includes:
partitioning the target region into at least two sector-shaped sub-regions centered on a target position point according to the first sub-partition method to obtain a first region group, the first region group including the at least two sector-shaped sub-regions and a central sub-region, and the central sub-region being the region where the target position point is located;
partitioning the target region into at least two annular sub-regions centered on the target position point according to the second sub-partition method to obtain a second region group, the second region group including the at least two annular sub-regions and the central sub-region;
where the target position point is a position point of the preset urban entity corresponding to the central node in the target region, an i-th region partition subset includes the first region group and the second region group, the i-th region partition subset is the region partition subset corresponding to the i-th fold partition among the M region partition subsets, the position parameters of the first sub-partition method are different in the different fold partitions, and the distance parameters of the second sub-partition method are different in the different fold partitions.

Specifically, the first sub-partition method can be the foregoing direction-aware partition method. The second sub-partition method can be the foregoing distance-aware partition method.

The position parameters of the first sub-partition method are different in the different fold partitions, which can specifically refer to: each time re-partitioning, taking the central node as a rotation center, rotating a preset angle for each partitioning line of previous partitioning, wherein the preset angle can be 5°, 10° or other angles.

The distance parameters of the second sub-partition method are different in the different fold partitions, which can specifically refer to: in different fold partitions, distances between each partitioning line and central node are different.

The foregoing first region group can be a set of sub-regions obtained by performing a one-time partitioning on the target region based on the first sub-partition method. Correspondingly, the second region group can be a set of sub-regions obtained by performing a one-time partitioning on the target region based on the second sub-partition method.

It can be understood that since the target partition method includes the first sub-partition method and the second sub-partition method, that is, each fold partition includes these two kinds of partition methods, and each fold partition includes two partition results. It can be understood that after performing the foregoing M-fold region partitioning, M first region groups and M second region groups can be obtained. Each region partition subset includes a first region group and a second region group. The region partition set includes M first region groups and M second region groups. In one embodiment of the present disclosure, the region partition set can include the foregoing

$$\{ {𝒩}_{{s}_{k}^{m}} ( {v}_{i} ) \vert k = 0 , 1 , … , {n}_{s} - 1 \}$$

and [symbol]
={rₖ^{m}|k=0, 1, . . . , nᵣ−1}, at this time, the foregoing Mₛ=Mᵣ=M.

In this embodiment, since each fold partition includes a partition result obtained based on the first sub-partition method and a partition result obtained based on the second sub-partition method, thus further enriching ways of partitioning the target region, and thereby further enriching contents in the region partition set, so that it is conductive to improve the effect of partitioning the target area.

Optionally, the updating the node features of the central node based on the target regional features of the sub-regions in the region partition set to obtain the target feature data includes:
fusing the target regional features of the sub-regions in each first sub-region group respectively to obtain M first feature data, and the M first feature data corresponding one-to-one with the M region partition subsets;
fusing the target regional features of the sub-regions in each second sub-region group respectively to obtain M second feature data, and the M second feature data corresponding one-to-one with the M region partition subsets;
updating the node features of the central node based on the M first feature data and the M second feature data to obtain the target feature data.

It can be understood that after the foregoing partitioning process of the target region, the region partition set can include M first region groups and M second region groups. Then, for each sub-region in each region group (first region group and second region group) in the region partition set, respectively aggregating the node features corresponding to all nodes located within the same sub-region to obtain the regional features of each sub-region.

Specifically, since a first region group includes at least two sub-regions obtained by a one-time partition, and the at least two sub-regions jointly form the foregoing target region, after obtaining the regional features of each sub-region in the first region group based on the feature aggregation process, the regional features of all sub-regions in the first region group can be further fused to obtain a first feature data that can represent the node features of different spatial positions in the neighborhood.

Correspondingly, since a second region group includes at least two sub-regions obtained by a one-time partition, and the at least two sub-regions jointly form the foregoing target region, after obtaining the regional features of each sub-region in the second region group based on the feature aggregation process, the regional features of all sub-regions in the second region group can be further fused to obtain a second feature data that can represent the node features of different spatial positions in the neighborhood.

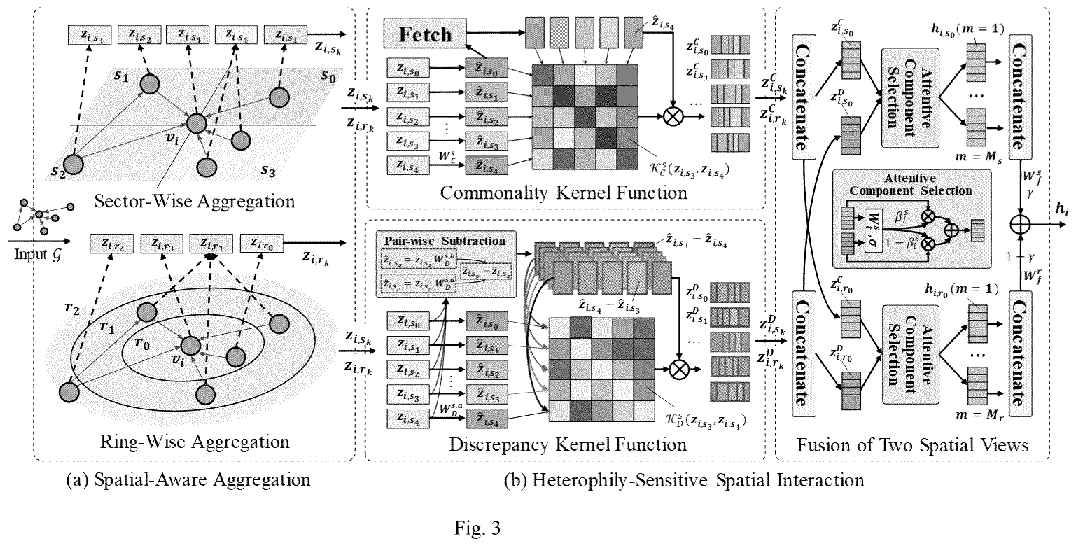

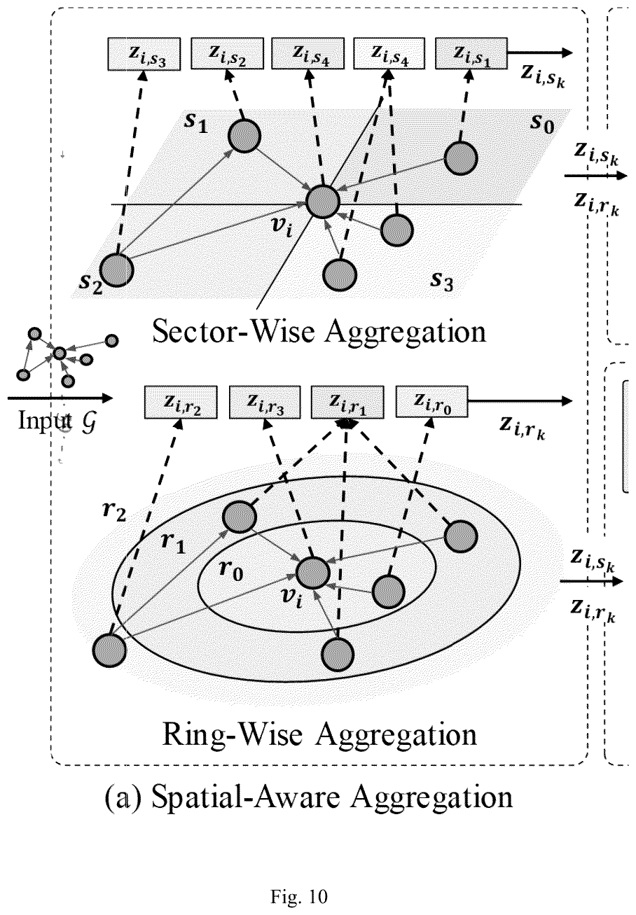

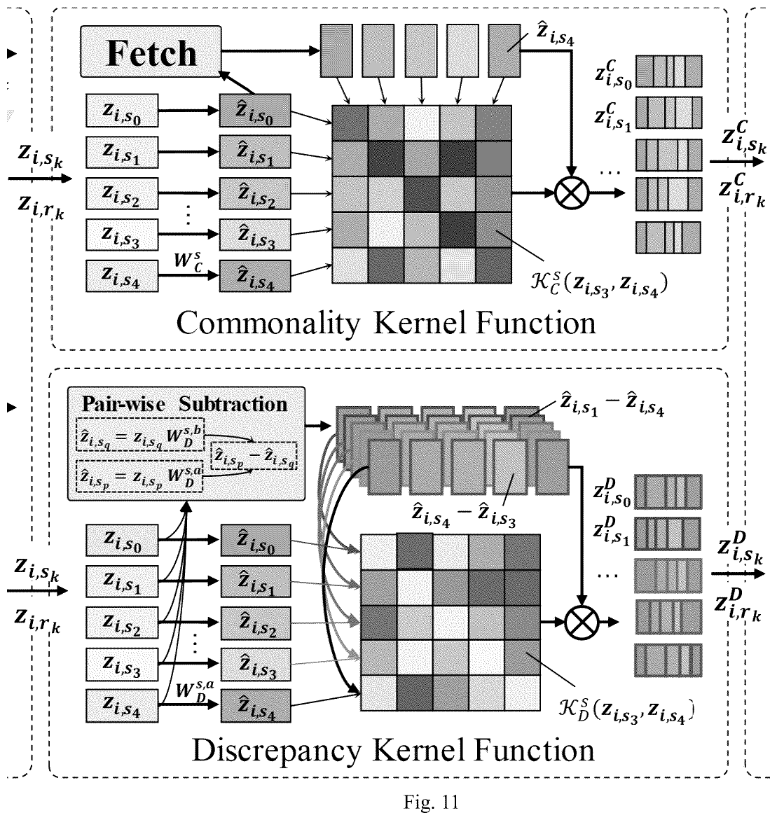

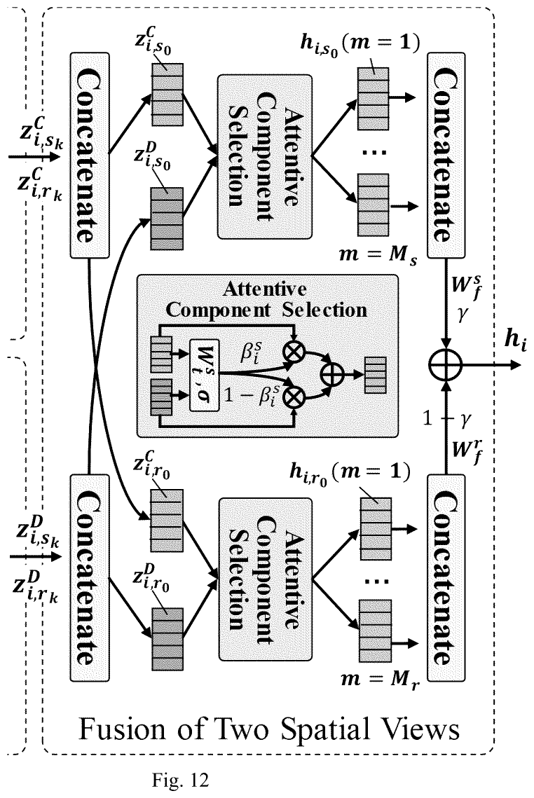

The fusion of the foregoing regional features can be performed by using common fusion methods in related technologies, for example, concatenating the regional features of different sub-regions, or constructing a feature matrix based on the regional features of different sub-regions. For example, as shown in FIG. 3 together with FIGS. 10-12, in an embodiment of the present disclosure, taking the partition of direction view as an example, for a direction-aware neighborhood

$$\{ {𝒩}_{{s}_{k}^{m}} ( {v}_{i} ) \vert k = 0 , 1 , … , {n}_{s} \}$$

(including the central node itself) under the M-th fold partition, graph convolution can be used to perform feature aggregation for each neighborhood

$${𝒩}_{{s}_{k}^{m}} ( {v}_{i} ) :$$

$${z}_{i , {s}_{k}^{m}}^{( l + 1 )} = {\sum }_{j ∈ {𝒩}_{{s}_{k}^{m}}^{m}} ( {v}_{i} ) \frac{1}{\sqrt{\vert 𝒩 ( {v}_{i} ) \vert \cdot \vert 𝒩 ( {v}_{j} ) \vert}} {h}_{j}^{( l )} {W}_{{s}_{k}^{m}}^{( l )}$$

where the graph convolution can include multiple network sides, and multiple network layers are connected in sequence, and the input of each network layer is the output of the previous network side, and the input of the first network side is the direction-aware neighborhood

$$\{ {𝒩}_{{s}_{k}^{m}} ( {v}_{i} ) \vert k = 0 , 1 , … , {n}_{s} \} .$$

$${z}_{i , {s}_{k}^{m}}^{( l + 1 )}$$

represents the information aggregated from sector sₖ by the (l+1)-th layer network, and takes it as the representation vector of sector sₖ under the m-th fold partition; hⱼ^{(l)} represents the feature of neighbor vⱼ output by the l-th layer network

$$( {h}_{j}^{( 0 )} = {x}_{j} ) ; {W}_{{s}_{k}^{m}}^{( 1 )}$$

is a trainable transformation matrix, which is used to extract useful information from the neighbor node features. Similarly, as shown in FIG. 3, in the distance view, the following formula can be used to aggregate nodes in each ring separately:

$${z}_{i , {r}_{k}^{m}}^{( l + 1 )} = {\sum }_{j ∈ {𝒩}_{{r}_{k}^{m ( {v}_{i} )}}} \frac{1}{\sqrt{\vert 𝒩 ( {v}_{i} ) \vert \cdot \vert 𝒩 ( {v}_{j} ) \vert}} {h}_{j}^{( l )} {W}_{{r}_{k}^{m}}^{( l )}$$

wherein

$${z}_{i , {r}_{k}^{m}}^{( l + 1 )}$$

is the representation vector of the annulus rₖ under the m-th partition, and

$${W}_{{r}_{k}^{m}}^{( l )}$$

is another transformation matrix used to learn the node features of the neighbors at different distances.

In this embodiment, the node features of the central node are updated based on the M first feature data and the M second feature data, thus, since the partition results of the M-fold region partition are fused in the process of updating the node features of the central node, and the results of different fold region partitions can complement each other, therefore, it is conductive to better mine the semantic differences brought by different spatial relations under the same topological structure, and thereby improving the quality of the generated target feature data.

Optionally, the fusing the target regional features of the sub-regions in each first sub-region group respectively to obtain M first feature data includes:
concatenating the target regional features of the sub-regions within the each first sub-region group respectively to obtain the M first feature data.

Specifically, for the representation of each sector/annular region under the m-th fold partition, the embodiment of the present disclosure is different from the conventional graph neural network that uses summation or averaging to fuse neighborhood representations (because using this method would mix the features of neighboring nodes with different spatial distributions), and instead uses concatenation to perform the fusion. In this way, the features at different concatenation positions of the first feature data obtained after concatenation represent the features corresponding to different spatial positions, thereby avoiding mixing the features of neighboring nodes with different spatial distributions in the first feature data obtained after the fusion.

As shown in FIG. 3, in one embodiment of the present disclosure, the following formula can be used to implement the process of obtaining the M first feature data by concatenating the regional features of the sub-regions within each first sub-region group:

$${z}_{i , {s}^{m}}^{( l + 1 )} = {‖}_{k = 0}^{{n}_{s}} {z}_{i , {s}_{k}^{m}}^{( l + 1 )}$$

wherein

$${z}_{i , {s}^{m}}^{( l + 1 )}$$

is a conventional fusion method, representing the representation of the neighborhood in the direction view under the m-th fold partition, that is,

$${z}_{i , {s}^{m}}^{( l + 1 )}$$

represents a vector representation after a first sub-region group is fused.

In this embodiment, the regional features of the sub-regions within each first sub-region group are concatenated respectively to obtain the M first feature data, thereby avoiding mixing the features of neighboring nodes with different spatial distributions in the first feature data obtained after the fusion.

Optionally, the fusing the target regional features of the sub-regions in each second sub-region group respectively to obtain M second feature data includes:
concatenating the target regional features of the sub-regions within each second sub-region group respectively to obtain the M second feature data.

As shown in FIG. 3, in one embodiment of the present disclosure, the following formula can be used to implement the process of obtaining the M second feature data by concatenating the regional features of the sub-regions within each second sub-region group:

$${z}_{i , {r}^{m}}^{( l + 1 )} = {‖}_{k = 0}^{{n}_{r}} {z}_{i , {r}_{k}^{m}}^{( l + 1 )}$$

wherein

$${z}_{i , {r}^{m}}^{( l + 1 )}$$

represents the representation of the neighborhood in the distance view under the m-th fold partition, that is,

$${z}_{i , {r}^{m}}^{( l + 1 )}$$

represents a vector representation after a second sub-region group is fused.

In this embodiment, the regional features of the sub-regions within each second sub-region group are concatenated respectively to obtain the M second feature data, thereby avoiding mixing the features of neighboring nodes with different spatial distributions in the second feature data obtained after the fusion.

Optionally, the updating the node features of the central node based on the M first feature data and the M second feature data to obtain the target feature data includes:
concatenating the M first feature data to obtain a first updating feature;
concatenating the M second feature data to obtain a second updating feature;
performing weighted summation of the first updating feature and the second updating feature to obtain the target feature data.

As shown in FIG. 3, in one embodiment of the present disclosure, the foregoing process of concatenating the M first feature data to obtain the first updating feature can be implemented by the following formula:

$${z}_{i , s}^{( l + 1 )} = {‖}_{m = 1}^{{M}_{s}} {z}_{i , {s}^{m}}^{( l + 1 )}$$

where z_{i,s}^{(l+1)} represents the first updating feature, that is, concatenating the M first feature data obtained by M-fold partitioning in sequence, and the z_{i,s}^{(l+1)} represents the vector representation after fusing the M first sub-region groups4.

At the same time, the foregoing process of concatenating the M second feature data to obtain the second updating feature can be implemented by the following formula:

$${z}_{i , r}^{( l + 1 )} = {‖}_{m = 1}^{{M}_{r}} {z}_{i , {r}^{m}}^{( l + 1 )}$$

where z_{i,r}^{(l+1)} represents the second updating feature, that is, concatenating the M second feature data obtained by M-fold partitioning in sequence, and the z_{i,r}^{(l+1)} represents the vector representation after fusing the M second sub-region groups.

The process of performing weighted summation of the first updating feature and the second updating feature to obtain the target feature data can be implemented by the following formula:

$${h}_{i}^{{( l + 1 )}_{=}} γ {z}_{i , s}^{( l + 1 )} {W}_{f , s}^{( l + 1 )} + ( 1 - γ ) {z}_{i , r}^{( l + 1 )} {W}_{f , r}^{( l + 1 )}$$

where hᵢ^{(l+1)} represents the representation vector of the central node vᵢ output by the (l+1)-th layer network (that is, the target feature data). W_{f,s}^{(l+1)} and W_{f,r}^{(l+1)} are two learnable transformation matrices that map the representation vectors in two spatial views to the same space. γϵ(0,1) is also a trainable parameter that learns how to allocate the importance of two spatial views according to the target task.

In this embodiment, the M first feature data are concatenated to obtain the first updated feature, and the M second feature data are concatenated to obtain the second updated feature. In this way, the foregoing aggregation process does not mix the features of neighboring nodes in different spatial groups, and can retain the spatial information of different neighboring nodes in the representation of the central node.

Optionally, the generating the relation set based on the regional features of the sub-regions in the region partition set includes:
calculating the similarity between the regional features of a target sub-region and the regional features of each of the sub-regions in the region partition set to obtain the common information, wherein the common information includes at least two pieces of similarity information corresponding one-to-one with the at least two sub-regions, and the target sub-region is any one of the sub-regions in the region partition set.

Specifically, after calculating the regional features of each sub-region based on the foregoing embodiment, a commonality kernel function can be further designed to capture the common information between spatial groups.

Where

$${z}_{i , {s}_{k}^{m}}^{( l + 1 )}$$

represents the information aggregated from the sector sₖ by the (l+1)-th layer network, that is, the regional feature of the sector sₖ is

$${z}_{i , {s}_{k}^{m}}^{( l + 1 )} .$$

Correspondingly, the foregoing

$${z}_{i , {r}_{k}^{m}}^{( l + 1 )}$$

is the representation vector of the ring rₖ in the m-th fold partition, that is, the regional feature of ring rₖ is

$${z}_{i , {r}_{k}^{m}}^{( l + 1 )} ,$$

and the superscript l represents the output of the l-th layer network. In the present embodiment, the method provided by the present embodiment will be used in each network layer l and each fold spatial partition m. For convenience of expression, the present embodiment omits superscripts l and m, that is, z_{i,s}_{ₖ} mentioned below represents the foregoing

$${z}_{i , {s}_{k}^{m}}^{( l + 1 )} ,$$

and z_{i,r}_{ₖ} represents

$${z}_{i , {r}_{k}^{m}}^{( l + 1 )} .$$

In one embodiment of the present disclosure, taking the directional view as an example, based on the representation {z_{i,s}_{ₖ}|k=0, 1, . . . , nₛ} of each sector learned in the node vᵢ by the rotation-scaling spatial-aware neighborhood aggregation module, a commonality kernel function [symbol] (⋅,⋅) models the similarity degree between two sectors sₚ and s_{q}, and is specifically defined as follows:

$${𝒦}_{C}^{s} ( {z}_{i , {s}_{p}} , {z}_{i , {s}_{q}} ) = 〈 {\hat{z}}_{i , {s}_{p}} , {\hat{z}}_{i , {s}_{q}} 〉$$

$${\hat{z}}_{i , {s}_{k}} = {z}_{i , {s}_{k}} {W}_{C}^{s}$$

where [symbol] ⋅,⋅ [symbol] represents the inner product of two representation vectors, W_{C}^{s} is a learnable transformation matrix, which is used to extract common features between sectors. The larger the value output by the commonality kernel function, the higher the similarity between the two sectors, that is, the sₚ represents the target sub-region, the s_{q} is any one of the sector-shaped sub-regions in the region partition set, and the [symbol] (z_{i,s}_{ₚ}, z_{i,s}_{_{q}}) is the similarity information between the regional features of the sub-region sₚ and the sub-region s_{q}. Similarly, in the distance view, a commonality kernel function [symbol] (⋅,⋅) parameterized by W_{C}^{r} can also be used to extract useful common information between different rings and obtain enhanced ring representations z_{i,r}_{ₚ}^{C}. The specific formula is as follows:

$${𝒦}_{C}^{r} ( {z}_{i , {r}_{p}} , {z}_{i , {r}_{q}} ) = 〈 {\hat{z}}_{i , {r}_{p}} , {\hat{z}}_{i , {r}_{q}} 〉$$

$${\hat{z}}_{i , {r}_{k}} = {z}_{i , {r}_{k}} {W}_{C}^{r}$$

where in the present embodiment, the rₚ represents the target sub-region in the distance partition scenario; the r_{q} represents any one of the annular sub-regions in the region partition set; [symbol] (z_{i,r}_{ₚ}, z_{i,r}_{_{q}}) represents the similarity information between the regional features of the sub-region rₚ and the sub-region r_{q}.

In the present embodiment, by calculating the similarity between the regional features of the target sub-region and the regional features of each sub-region in the region partition set, the common information corresponding to the target sub-region is obtained, thereby realizing the process of generating the common information corresponding to each sub-region.

Optionally, the generating the relation set based on the regional features of the sub-regions in the region partition set includes:
calculating the difference degree between the regional features of the target sub-region and the regional features of each of the sub-regions in the region partition set to obtain the difference information, wherein the difference information includes at least two pieces of difference degree information corresponding one-to-one with the at least two sub-regions, and the target sub-region is any one of the sub-regions in the region partition set.

Embodiments of the present disclosure further design another discrepancy kernel function to capture the dissimilarity between the central node and the sub-regions, as well as between different sub-regions. Taking the partition in the direction view as an example for illustration. Specifically, taking the sector representations {z_{i,s}_{ₖ}|k=0, 1, . . . , nₛ} learned by the rotation-scaling spatial-aware neighborhood aggregation module as input, the discrepancy kernel function is defined as:

$${𝒦}_{D}^{r} ( {z}_{i , {r}_{p}} , {z}_{i , {r}_{q}} ) = 〈 {z}_{i , {r}_{p}} {W}_{D}^{r , a} , ( {z}_{i , {r}_{p}} {W}_{D}^{r , a} - {z}_{i , {r}_{q}} {W}_{D}^{r , b} ) 〉$$

where W_{D}^{s,a} and W_{D}^{s,b} are two learnable transformations for extracting the difference of sector s_{q} relative to sₚ, that is, [symbol] (z_{i,s}_{ₚ}, z_{i,s}_{_{q}}) represents the difference degree between the regional features of sub-region s_{q} and sub-region sₚ. The kernel function can be regarded as calculating the dissimilarity between two input vectors, that is, when the difference between two sectors is larger, the output value of the kernel function is higher.

In the same way, the present disclosure also defines a discrepancy kernel function [symbol] (⋅,⋅) for the ring representation learning in the distance view, which uses W_{D}^{r,a} and W_{D}^{r,b} to extract the difference information between rings and generate enhanced ring representations z_{i,r}_{ₚ}^{D}. Under the action of the discrepancy kernel function, each spatial group (including the central node) can perceive the diverse difference distribution of other spatial groups. The specific formula is as follows:

$${𝒦}_{D}^{r} ( {z}_{i , {r}_{p}} , {z}_{i , {r}_{q}} ) = 〈 {z}_{i , {r}_{p}} {W}_{D}^{r , a} , ( {z}_{i , {r}_{p}} {W}_{D}^{r , a} - {z}_{i , {r}_{q}} {W}_{D}^{r , b} ) 〉$$

where [symbol] (z_{i,r}_{ₚ}, z_{i,r}_{_{q}}) represents the difference degree information between sub-regions rₚ and r_{q}, the sub-region rₚ is the foregoing target sub-region, and the sub-region r_{q} is any one of the annular sub-regions in the region partition set.

In this embodiment, by calculating the difference degree between the regional features of the target sub-region and the regional features of each of the sub-regions in the region partition set, the difference information corresponding to the target sub-region is obtained, thereby realizing the generation process of the difference information.

Optionally, the updating the regional features of each of the sub-regions based on the relation set to obtain the target regional features of each of the sub-regions includes:
updating the regional features of each of the sub-regions based on the common information in the relation set to obtain a first feature of each of the sub-regions;
updating the regional features of each of the sub-regions based on the difference information in the relation set to obtain a second feature of each of the sub-regions;
performing weighted summation of the first feature and the second feature for each of the sub-regions to obtain the target regional features of each of the sub-regions.

The foregoing updating the regional features of each of the sub-regions based on the common information in the relation set to obtain the first feature of each of the sub-regions specifically means: updating the regional features of the sub-region itself based on the common information corresponding to each of the sub-region respectively to obtain the first feature of each of the sub-regions. Correspondingly, the updating the regional features of each of the sub-regions based on the difference information in the relation set to obtain the second feature of each of the sub-regions specifically means: updating the regional features of the sub-region itself based on the difference information corresponding to each of the sub-region respectively to obtain the second feature of each of the sub-regions. The first feature and the second feature are both updated regional features for the sub-regions.

For ease of understanding, the following takes the example of updating the regional features of the foregoing target sub-regions to obtain the first and the second features corresponding to the target sub-regions, and explains the process of updating the regional features in the present disclosure:

When the target sub-region is a sector-shaped sub-region sₚ, updating the regional features of the target sub-region based on the common information corresponding to the target sub-region to obtain the first feature of the target sub-region can be specifically implemented by the following formula:

$${z}_{i , {s}_{p}}^{C} = {\sum }_{q = 0}^{{n}_{s}} {α}_{pq}^{C , s} {z}_{i , {s}_{q}} {W}_{C}^{s}$$

$${α}_{pq}^{C , s} = \frac{exp ( {𝒦}_{C}^{s} ( {z}_{i , {s}_{p}} , {z}_{i , {s}_{q}} ) )}{{\sum }_{k = 0}^{{n}_{s}} exp ( {𝒦}_{C}^{s} ( {z}_{i , {s}_{p}} , {z}_{i , {s}_{k}} ) )}$$

where the coefficient α_{pq}^{C,s} is used to represent the similarity degree between sectors, the z_{i,r}_{ₚ} is the first feature obtained after updating the regional features of the target sub-region sₚ, and [symbol] (z_{i,s}_{ₚ}, z_{i,s}_{_{q}}) is the similarity information between the regional features of the sub-region sₚ and the sub-region s_{q}.

Correspondingly, updating the regional features of the target sub-regions based on the difference information corresponding to the target sub-regions to obtain the second feature of the target sub-regions can be specifically implemented by the following formula:

$${z}_{i , {s}_{p}}^{D} = {\sum }_{q = 0}^{{n}_{s}} {α}_{pq}^{D , s} ( {z}_{i , {s}_{p}} {W}_{D}^{s , a} - {z}_{i , {s}_{q}} {W}_{D}^{s , b} )$$

$${α}_{pq}^{D , s} = \frac{exp ( {𝒦}_{D}^{s} ( {z}_{i , {s}_{p}} , {z}_{i , {s}_{q}} ) )}{{\sum }_{k = 0}^{{n}_{s}} exp ( {𝒦}_{D}^{s} ( {z}_{i , {s}_{p}} , {z}_{i , {s}_{k}} ) )}$$

wherein z_{i,s}_{ₚ}^{D} represents the second feature obtained after updating the regional features of the target sub-region sₚ, and [symbol] (z_{i,s}_{ₚ}, z_{i,s}_{_{q}}) is the difference degree information between the regional features of the sub-region sₚ and the sub-region s_{q}.

When the target sub-region is the annular sub-region rₚ, updating the regional features of the target sub-region based on the common information corresponding to the target sub-region to obtain the first feature of the target sub-region can be specifically implemented by the following formula:

$${z}_{i , {r}_{p}}^{C} = {\sum }_{q = 0}^{{n}_{r}} {α}_{pq}^{C , r} {z}_{i , {r}_{q}} {W}_{C}^{r}$$

$${α}_{pq}^{C , r} = \frac{exp ( {𝒦}_{C}^{r} ( {z}_{i , {r}_{p}} , {z}_{i , {r}_{q}} ) )}{{\sum }_{k = 0}^{{n}_{r}} exp ( {𝒦}_{C}^{r} ( {z}_{i , {r}_{p}} , {z}_{i , {r}_{k}} ) )}$$

where in the present embodiment, the rₚ represents the target sub-region in the distance partition scenario; r_{q} represents any one of the annular sub-regions in the foregoing region partition set; [symbol] (z_{i,r}_{ₚ}, z_{i,r}_{_{q}}) represents the similarity information between the regional features of the sub-region rₚ and the sub-region r_{q}; z_{i,r}_{ₚ}^{C} is the first feature obtained after updating the regional features of the target sub-region rₚ.

Correspondingly, updating the regional features of the target sub-region based on the difference information corresponding to the target sub-region to obtain the second feature of the target sub-region can be specifically implemented by the following formula:

$${z}_{i , {r}_{p}}^{D} = {\sum }_{q = 0}^{{n}_{r}} {α}_{pq}^{D , r} ( {z}_{i , {r}_{p}} {W}_{D}^{r , a} - {z}_{i , {r}_{q}} {W}_{D}^{r , b} )$$

$${α}_{pq}^{D , r} = \frac{exp ( {𝒦}_{D}^{s} ( {z}_{i , {s}_{p}} , {z}_{i , {s}_{q}} ) )}{{\sum }_{k = 0}^{{n}_{r}} exp ( {𝒦}_{D}^{r} ( {z}_{i , {r}_{p}} , {z}_{i , {r}_{k}} ) )}$$

where [symbol] (z_{i,r}_{ₚ}, z_{i,r}_{_{q}}) represents the difference degree information between the sub-region rₚ and the sub-region r_{q}; z_{i,r}_{ₚ} represents the second feature obtained after updating the regional features of the target sub-region rₚ; the sub-region rₚ is the foregoing target sub-region; the sub-region r_{q} is any one of the annular sub-regions in the region partition set.

Specifically, through these two kernel functions, the representation learning on urban graphs can be enhanced by using the common information and the difference information between spatial groups. However, in various application scenarios, different urban entities on urban graphs may have different degrees of spatial heterophily. Embodiments of the present disclosure design an attentive gate mechanism that adaptively learns the importance of the common information and the difference information for node representation learning in specific tasks through an end-to-end manner.

Specifically, taking the direction view as an example, for the central node vᵢ, the present disclosure integrates the representations of each sector and the central node itself by concatenation, and then uses this as input to generate a control coefficients through a learnable transformation:

$${{β}_{i}^{s} = σ ( {‖}_{j ∈ \{ C , D \}} ‖}_{k = 0}^{{n}_{s}} {z}_{i , {s}_{k}}^{j} {W}_{t}^{s} )$$

where Wₜ^{s} represents the transformation matrix for generating the control coefficient, and σ represents the Sigmoid function, which limits the range of the output coefficients to (0, 1). The coefficient controls the proportion of common information and difference information, and combines the two kinds of information according to their importance to update the sector representation vector:

$${h}_{i , {s}_{k}} = {β}_{i}^{s} \cdot {z}_{i , {s}_{k}}^{C} + ( 1 - {β}_{i}^{s} ) \cdot {z}_{i , {s}_{k}}^{D}$$

where h_{i,s}_{ₖ} is the target regional feature obtained after weighted summation in this scenario.

Similarly, in the distance view, another control coefficient βᵢ^{r} can also be learned to control the proportion of two kinds of information in the ring representation vector, which can be expressed by the following formula:

$${{β}_{i}^{r} = σ ( {‖}_{j ∈ \{ C , D \}} ‖}_{k = 0}^{{n}_{r}} {z}_{i , {s}_{r}}^{j} {W}_{t}^{r} )$$

$${h}_{i , {s}_{r}} = {β}_{i}^{r} \cdot {z}_{i , {r}_{k}}^{C} + ( 1 - {β}_{i}^{r} ) \cdot {z}_{i , {r}_{k}}^{D}$$

where h_{i,s}_{ᵣ} is the target regional feature obtained after weighted summation in this scenario.

In this embodiment, by updating the regional features of each of the sub-regions based on the common information in the relation set to obtain a first feature of each of the sub-regions; and updating the regional features of each of the sub-regions based on the difference information in the relation set to obtain a second feature of each of the sub-regions; then, performing weighted summation of the first feature and the second feature for each of the sub-regions to obtain the target regional features of each of the sub-regions, thus ensuring that the obtained target regional features can contain the common information within the neighborhood and the diverse difference information between sub-regions.

Optionally, the updating the node features of the central node based on the M first feature data and the M second feature data to obtain the target feature data includes:
concatenating the M first feature data to obtain a first updating feature;
concatenating the M second feature data to obtain a second updating feature;
performing weighted summation of the first updating feature and the second updating feature to obtain the target feature data.

After the interaction process between the foregoing sub-regions, each sub-region can contain the common information in the neighborhood and the diverse difference information between the sub-regions, which is very important for learning heterophily urban graphs. Then, the representations of each of the sub-regions are fused and an overall description of the neighborhood information is obtained. First, for the m-th fold partition in the direction view/distance view, the representation vectors of the sub-regions (sectors/rings) in each region group can be concatenated to obtain the neighborhood representation under this partition. Here, unlike general GNN models that use summation or averaging for fusion, the present disclosure uses concatenation to ensure that different spatial groups can still be distinguished in the neighborhood representation, avoiding mixing difference distributions with spatial diversity. Then, the neighborhood representations under Mₛ-fold partition in the direction view and Mᵣ-fold partition in the distance view respectively are concatenated to obtain the overall neighborhood representations in two views. The foregoing two consecutive concatenation operations can be uniformly expressed as:

$${h}_{i , s} = {\vert \vert}_{m = 1}^{{M}_{s}} ( {\vert \vert}_{k = 0}^{{n}_{s}} {h}_{i , {s}_{k}^{m}} ) , {h}_{i , r} = {\vert \vert}_{m = 1}^{{M}_{r}} ( {\vert \vert}_{k = 0}^{{n}_{r}} {h}_{i , {r}_{k}^{m}} )$$

Finally, through a learnable weighted summation, the neighborhood representations obtained in the direction view and distance view are fused, and the representation of the central node is updated:

$${h}_{i} = γ {h}_{i , s} {W}_{f}^{s} + ( 1 - γ ) {h}_{i , r} {W}_{f}^{r}$$

wherein W_{f}^{s} and W_{f}^{r} are two learnable transformation matrices that map the representation vectors in two spatial views to the same space. hᵢ is the target feature data corresponding to the foregoing central node. γϵ(0,1) is also a trainable parameter that learns how to allocate the importance of two spatial views according to the target task.

Optionally, the generating the regional features of each of the sub-regions based on the feature set includes:
aggregating the node features corresponding to all nodes located within the same sub-region to obtain the regional features of each of the sub-regions.

The aggregating the node features corresponding to all nodes located within the same sub-region can be specifically: according to the feature aggregation method in the related technology, aggregating the node features of the nodes located within the same sub-region, and taking the aggregation result as the regional feature of that sub-region.

In this embodiment, by partitioning the target region into at least two sub-regions, and aggregating the node features corresponding to all nodes located within the same sub-region to obtain the regional features of each sub-region, it is possible to achieve separate aggregation of features for nodes at different spatial positions. Thus, it ensures that spatial information of urban entities can be fully considered in the process of generating the target feature data, to mine the semantic differences brought by different spatial relations under the same topological structure, and thereby improving the quality of the generated target feature data.

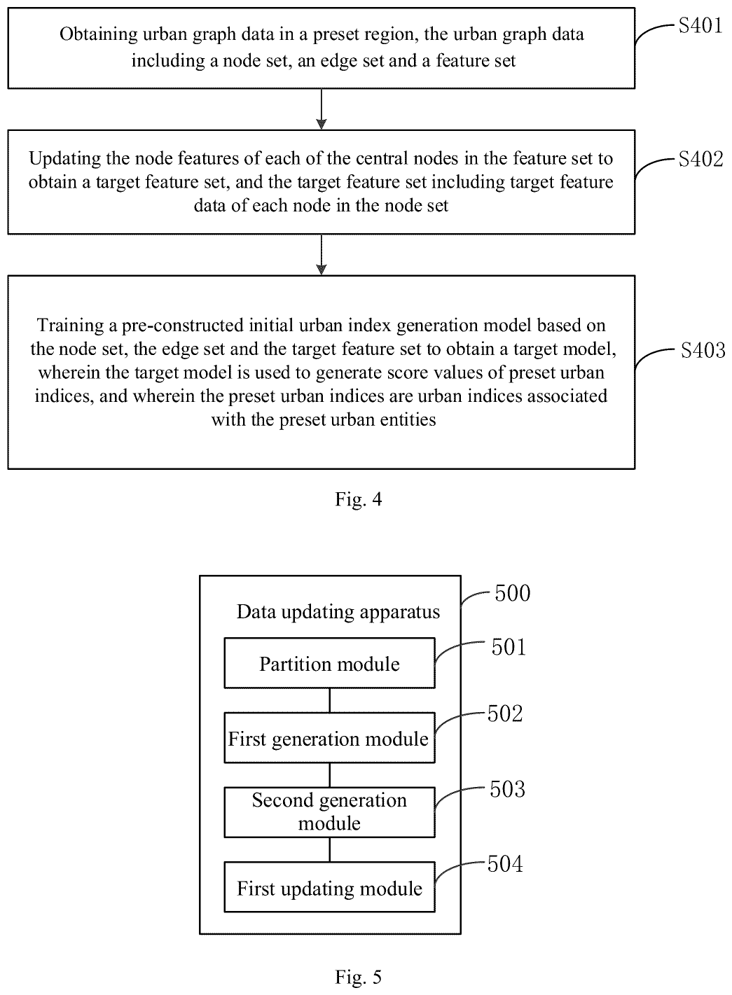

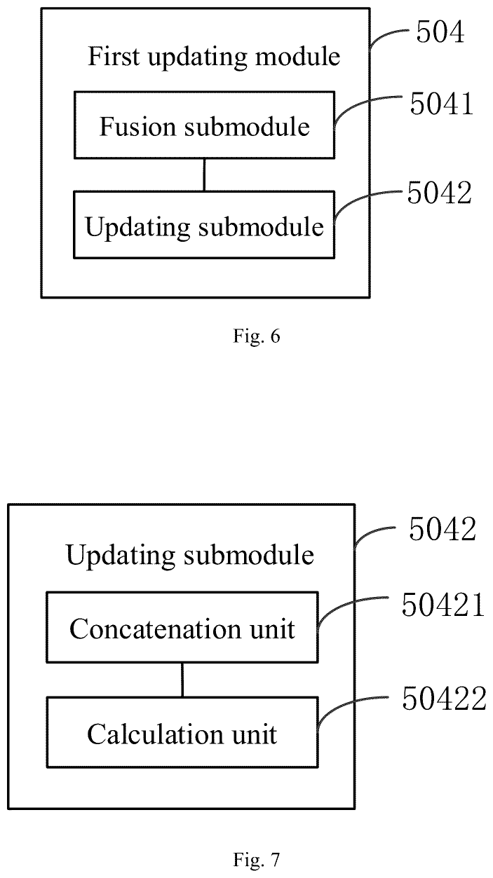

Referring to FIG. 4, FIG. 4 is a flow chart of a model training method according to an embodiment of the present disclosure. The model training method includes the following steps:
Step S401: obtaining urban graph data, the urban graph data including a node set, an edge set, and a feature set, the node set including central nodes corresponding to preset urban entities in the preset region, the edge set including neighborhoods corresponding to the central nodes, the neighborhoods including other nodes in the node set possessing connecting edges with the central nodes, the feature set including node features of the central nodes, the neighborhoods corresponding to a target region in the preset region, and the preset urban entities corresponding to the nodes in the neighborhood are located within the target region;
Step S402: updating the node features of each of the central nodes in the feature set based on the data updating method according to the foregoing embodiments to obtain a target feature set, and the target feature set including target feature data of each node in the node set;
Step S403: training a pre-constructed initial urban index generation model based on the node set, the edge set and the target feature set to obtain a target model, wherein the target model is used to generate score values of preset urban indices, and wherein the preset urban indices are urban indices associated with the preset urban entities.

The foregoing preset urban indices can be various types of urban indices common in related technologies, such as an urban prosperity index, an urban population mobility, and an urban crime rate index. When the preset urban index is an urban prosperity index, the initial urban index generation model can be the prosperity prediction model in the foregoing embodiments. Then, urban graph data can be constructed based on the method in the foregoing embodiments and the node features of each central node in the feature set can be updated based on the data updating method in the foregoing embodiments to obtain the target feature set. Then, a pre-constructed initial urban index generation model is trained based on the node set, the edge set, and the target feature set to obtain the target model. At this time, the score value is urban prosperity, that is, the trained target model can represent the urban prosperity based on the urban graph data.

Accordingly, when the preset urban index is urban population mobility, a urban graph data can be constructed based on the method in the foregoing embodiments, and the node feature updating and the model training process can be repeated to obtain a target model that can predict urban population mobility.

The foregoing initial urban index generation model can include the graph neural networks (GNNs) and a classifier in the foregoing embodiments. The classifier can be a scene classifier in the neural network model in related technologies. The urban graph data can be input into the initial urban index generation model, and the graph neural networks (GNNs) generates a target feature set based on the urban graph data. Then, the classifier predicts according to the target feature set, the node set, and the edge set to obtain corresponding score values. In the training process, the graph neural network can optimize the foregoing trainable parameters to improve the quality of the target feature data output by the graph neural network.

In specific training process, different losses can be used to optimize the network for different downstream tasks. For example, for node regression tasks (such as regional prosperity prediction), minimum mean squared error (MAE) can be used as a loss function to optimize the network. For node classification tasks (such as dangerous road section identification), cross entropy loss function can be used to train the model.

In one embodiment of the present disclosure, the foregoing target model is a prosperity prediction model. The updating the node features of each of the central nodes in the feature set based on the data updating method according to the foregoing embodiments to obtain the target feature set includes:
inputting the urban graph data into an initial urban index generation model, and updating the node features of each of the central nodes in the feature set by the graph neural network in the initial urban index generation model according to the method in the foregoing embodiments to obtain the target feature set.

Training the pre-constructed initial urban index generation model based on the node set, the edge set, and the target feature set to obtain the target model, includes:
inputting the node set, the edge set, and the target feature set into the classifier of the initial urban index generation model for prediction to obtain predicted score values;
constructing a loss function based on the predicted score values and preset label values, and updating the parameters of the graph neural network based on the loss function to obtain the target model, wherein the preset label values can be prosperity values of preset regions corresponding to the urban graph data that are predetermined artificially.

In embodiments of the present disclosure, a spatial heterophily graph neural network (SHGNN) can model and solve the spatial heterophily problem of urban graphs, and improve the representation ability for urban entities. Specifically, firstly, compared with general graph neural networks (homophily graph neural networks), for the problem of heterophily of urban graphs, the model of the present disclosure can consider both the commonality and difference of urban entities associated on urban graphs, and use the difference information to better learn distinguishable representations for associated but dissimilar urban entities. Secondly, compared with existing heterophily graph neural networks, the present disclosure can better solve the unique spatial heterophily problem on urban graphs. Thirdly, the model proposed by the present disclosure can identify the spatial positions of different neighbors in the neighborhood aggregation and message passing process, and then model the diversity of neighbor difference distribution under different spatial relations on urban graphs, that is, the spatial diversity of neighbor heterophily. Fourthly, existing heterophily graph neural networks merely consider limited neighbor differences and cannot model diverse difference distributions. The scheme of the present disclosure utilizes the characteristic that spatially close urban entities on urban graphs have high similarity, and reduces the diversity of difference distribution within groups by grouping neighbors spatially, and achieves a strategy of solving the problem of the spatial diversity of neighbor heterophily by dividing and conquering.

Referring to FIG. 5, FIG. 5 is a structural diagram of a data updating apparatus 500 according to an embodiment of the present disclosure. The data updating apparatus 500 includes:
a partition module 501 configured to partition a target region into at least two sub-regions to obtain a region partition set, wherein the target region corresponds to a neighborhood of a central node, the neighborhood includes other nodes possessing a connecting edge to the central node, and preset urban entities corresponding to the nodes in the neighborhood are located within the target region;
a first generation module 502 configured to generate regional features for each of the sub-regions based on node features of the nodes in the neighborhood;
a second generation module 503 configured to generate a relation set based on the regional features of the sub-regions in the region partition set, the relation set including at least two pieces of relation information corresponding one-to-one with the at least two sub-regions, and the relation information being used to represent the relation information between the corresponding sub-region and other sub-regions;
a first updating module 504 configured to update the node features of the central node based on the relation set and the regional features of the sub-regions in the region partition set to obtain target feature data.

Optionally, the relation information includes common information and difference information, the common information is used to represent shared information between the corresponding sub-region and other sub-regions, and the difference information is used to represent the difference information between the corresponding sub-region and other sub-regions.

Optionally, the second generation module 503 is specifically configured to calculate the similarity between the regional features of a target sub-region and the regional features of each of the sub-regions in the region partition set to obtain the common information, wherein the common information includes at least two pieces of similarity information corresponding one-to-one with the at least two sub-regions, and the target sub-region is any one of the sub-regions in the region partition set.

Optionally, the second generation module 503 is specifically configured to calculate the difference degree between the regional features of the target sub-region and the regional features of each of the sub-regions in the region partition set to obtain the difference information, wherein the difference information includes at least two pieces of difference degree information corresponding one-to-one with the at least two sub-regions, and the target sub-region is any one of the sub-regions in the region partition set.

Optionally, the first updating module 504 is specifically configured to update the regional features of each of the sub-regions based on the relation set to obtain target regional features of each of the sub-regions;
the first updating module 504 is further specifically configured to update the node features of the central node based on the target regional features of the sub-regions in the region partition set to obtain the target feature data.

Optionally, the first updating module 504 is specifically configured to update the regional features of each of the sub-regions based on the common information in the relation set to obtain a first feature of each of the sub-regions;
the first updating module 504 is further specifically configured to update the regional features of each of the sub-regions based on the difference information in the relation set to obtain a second feature of each of the sub-regions;
the first updating module 504 is further specifically configured to perform weighted summation of the first feature and the second feature for each of the sub-regions to obtain the target regional features of each of the sub-regions.

Optionally, the partition module 501 is configured to perform an M-fold region partition on the target region based on a target partition method to obtain the region partition set, the region partition set includes M region partition subsets corresponding one-to-one with the M-fold region partition, each of the region partition subsets includes at least two sub-regions, different fold partitions in the M-fold region partition corresponding to different partition parameters, the M is an integer greater than 1, and the partition parameters includes at least one of the following: position parameters of partitioning lines in the target region and distance parameters between the different partitioning lines.

Optionally, the target partition method includes a first sub-partition method and a second sub-partition method, and performing an i-th fold partition in the M-fold region partition on the target region based on the target partition method includes:
partitioning the target region into at least two sector-shaped sub-regions centered on a target position point according to the first sub-partition method to obtain a first region group, the first region group including the at least two sector-shaped sub-regions and a central sub-region, and the central sub-region being the region where the target position point is located;
partitioning the target region into at least two annular sub-regions centered on the target position point according to the second sub-partition method to obtain a second region group, the second region group including the at least two annular sub-regions and the central sub-region;
wherein the target position point is a position point of the preset urban entity corresponding to the central node in the target region, an i-th region partition subset includes the first region group and the second region group, the i-th region partition subset is the region partition subset corresponding to the i-th fold partition among the M region partition subsets, the position parameters of the first sub-partition method are different in the different fold partitions, and the distance parameters of the second sub-partition method are different in the different fold partitions.

Optionally, the first updating module includes:
a fusion submodule 5041 configured to fuse the target regional features of the sub-regions in each first sub-region group respectively to obtain M first feature data, and the M first feature data corresponding one-to-one with the M region partition subsets;
the fusion submodule 5041 further configured to fuse the target regional features of the sub-regions in each second sub-region group respectively to obtain M second feature data, and the M second feature data corresponding one-to-one with the M region partition subsets;
an updating submodule 5042 configured to update the node features of the central node based on the M first feature data and the M second feature data to obtain the target feature data.

Optionally, the fusion submodule 5041 is further specifically configured to concatenate the target regional features of the sub-regions within the each first sub-region group respectively to obtain the M first feature data.

Optionally, the fusion submodule 5041 is further specifically configured to concatenate the target regional features of the sub-regions within the each first sub-region group respectively to obtain the M first feature data.

Optionally, the updating submodule 5042 includes:
a concatenation unit 50421 configured to concatenate the M first feature data to obtain a first updating feature;
the concatenation unit 50421 further configured to concatenate the M second feature data to obtain a second updating feature;
a calculation unit 50422 configured to perform weighted summation of the first updating feature and the second updating feature to obtain the target feature data.

Optionally, the first generation module 502 is specifically configured to aggregate the node features corresponding to all nodes located within the same sub-region to obtain the regional features of each of the sub-regions.

It should be noted that the data updating apparatus 500 provided by the present embodiment can implement all the technical solutions of the foregoing data updating method embodiments, and thus can at least achieve all the foregoing technical effects. Details are not repeated here.

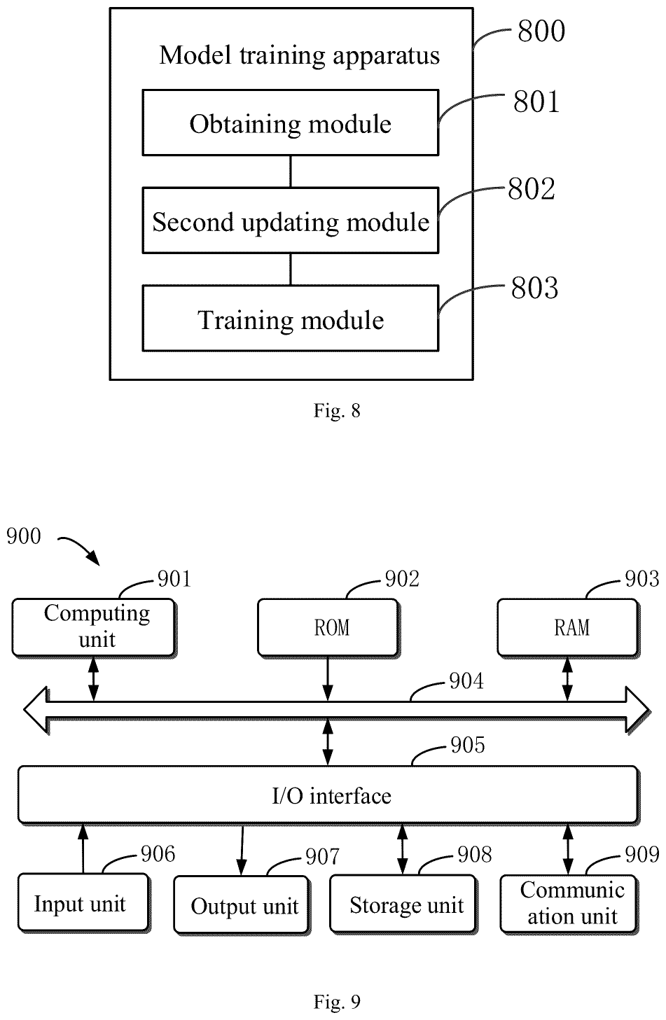

Referring to FIG. 8, FIG. 8 is a structural diagram of a model training apparatus 800 according to an embodiment of the present disclosure. The model training apparatus 800 includes:

an obtaining module 801 configured to obtain urban graph data, the urban graph data including a node set, an edge set, and a feature set, the node set including central nodes corresponding to preset urban entities in the preset region, the edge set including neighborhoods corresponding to the central nodes, the neighborhoods including other nodes in the node set possessing connecting edges with the central nodes, the feature set including node features of the central nodes, the neighborhoods corresponding to a target region in the preset region, and the preset urban entities corresponding to the nodes in the neighborhood are located within the target region;
a second updating module 802 configured to update the node features of each of the central nodes in the feature set based on the data updating method according to the foregoing embodiments to obtain a target feature set, and the target feature set including target feature data of each node in the node set;
a training module 803 configured to train a pre-constructed initial urban index generation model based on the node set, the edge set and the target feature set to obtain a target model, wherein the target model is used to generate score values of preset urban indices, and wherein the preset urban indices are urban indices associated with the preset urban entities.

It should be noted that the model training apparatus 800 provided by the present embodiment can implement all the technical solutions of the foregoing data updating method embodiments, and thus can at least achieve all the foregoing technical effects. Details are not repeated here.

In the technical solutions of the present disclosure, the obtaining, storage and application of user personal information involved are in compliance with the relevant laws and regulations, and do not violate public order and good morals.

According to embodiments of the present disclosure, an electronic device, a readable storage medium and a computer program product are further provided.

FIG. 9 is a schematic block diagram of an exemplary electronic device 900 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relations, and their functions, are meant to be exemplary only, and are not meant to limit implementations of the present disclosure described and/or claimed herein.

As shown in FIG. 9, the device 900 includes a computing unit 901. The computing unit 901 may carry out various suitable actions and processes according to a computer program stored in a read-only memory (ROM) 902 or a computer program loaded from a storage unit 908 into a random access memory (RAM) 903. The RAM 903 may as well store therein all kinds of programs and data required for the operation of the device 900. The computing unit 901, the ROM 902 and the RAM 903 are connected to each other through a bus 904. An input/output (I/O) interface 905 is also connected to the bus 904.

Multiple components in the device 900 are connected to the I/O interface 905. The multiple components include: an input unit 906, e.g., a keyboard, a mouse and the like; an output unit 907, e.g., a variety of displays, loudspeakers, and the like; a storage unit 908, e.g., a magnetic disk, an optic disc and the like; and a communication unit 909, e.g., a network card, a modem, a wireless transceiver, and the like. The communication unit 909 allows the device 900 to exchange information/data with other devices through a computer network and/or other telecommunication networks, such as the Internet.

The computing unit 901 may be any general purpose and/or special purpose processing components having a processing and computing capability. Some examples of the computing unit 901 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 901 carries out the aforementioned methods and processes, e.g., the data updating method or model training method. For example, in some embodiments, the data updating method or model training method may be implemented as a computer software program tangibly embodied in a machine readable medium such as the storage unit 908. In some embodiments, all or a part of the computer program may be loaded and/or installed on the device 900 through the ROM 902 and/or the communication unit 909. When the computer program is loaded into the RAM 903 and executed by the computing unit 901, one or more steps of the foregoing data updating method or model training method may be implemented. Optionally, in other embodiments, the computing unit 801 may be configured in any other suitable manner (e.g., by means of a firmware) to implement the data updating method or model training method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relation of client and server arises by virtue of computer programs running on respective computers and having a client-server relation to each other.

It is appreciated, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A data updating method, comprising:
partitioning a target region into at least two sub-regions to obtain a region partition set, wherein the target region corresponds to a neighborhood of a central node, the neighborhood comprises other nodes possessing a connecting edge to the central node, and preset urban entities corresponding to the nodes in the neighborhood are located within the target region;
generating regional features for each of the sub-regions based on node features of the nodes in the neighborhood;
generating a relation set based on the regional features of the sub-regions in the region partition set, wherein the relation set comprises at least two pieces of relation information corresponding to the at least two sub-regions in a one-to-one manner, and the relation information is used to represent relation information between the corresponding sub-region and other sub-regions;
updating the node features of the central node based on the relation set and the regional features of the sub-regions in the region partition set to obtain target feature data.

2. The data updating method according to claim 1, wherein the relation information comprises common information and difference information, the common information is used to represent shared information between the corresponding sub-region and other sub-regions, and the difference information is used to represent difference information between the corresponding sub-region and other sub-regions.

3. The data updating method according to claim 2, wherein the generating the relation set based on the regional features of the sub-regions in the region partition set comprises:
calculating similarity between regional features of a target sub-region and the regional features of each of the sub-regions in the region partition set to obtain the common information, wherein the common information comprises at least two pieces of similarity information corresponding to the at least two sub-regions in a one-to-one manner, and the target sub-region is any one of the sub-regions in the region partition set.

4. The data updating method according to claim 2, wherein the generating the relation set based on the regional features of the sub-regions in the region partition set comprises:
calculating the difference degree between the regional features of the target sub-region and the regional features of each of the sub-regions in the region partition set to obtain the difference information, wherein the difference information comprises at least two pieces of difference degree information corresponding to the at least two sub-regions in a one-to-one manner, and the target sub-region is any one of the sub-regions in the region partition set.

5. The data updating method according to claim 2, wherein the updating the node features of the central node based on the relation set and the regional features of the sub-regions in the region partition set to obtain the target feature data comprises:
updating the regional features of each of the sub-regions based on the relation set to obtain target regional features of each of the sub-regions;
updating the node features of the central node based on the target regional features of the sub-regions in the region partition set to obtain the target feature data.

6. The data updating method according to claim 5, wherein the updating the regional features of each of the sub-regions based on the relation set to obtain the target regional features of each of the sub-regions comprises:
updating the regional features of each of the sub-regions based on the common information in the relation set to obtain a first feature of each of the sub-regions;
updating the regional features of each of the sub-regions based on the difference information in the relation set to obtain a second feature of each of the sub-regions;
performing weighted summation of the first feature and the second feature for each of the sub-regions to obtain the target regional features of each of the sub-regions.

7. The data updating method according to claim 5, wherein the partitioning the target region into the at least two sub-regions to obtain the region partition set comprises:
performing an M-fold region partition on the target region based on a target partition method to obtain the region partition set, the region partition set comprising M region partition subsets corresponding one-to-one with the M-fold region partition, each of the region partition subsets comprising at least two sub-regions, different fold partitions in the M-fold region partition corresponding to different partition parameters, the M being an integer greater than 1, and the partition parameters comprising at least one of the following: position parameters of partitioning lines in the target region and distance parameters between the different partitioning lines.

8. The data updating method according to claim 7, wherein the target partition method comprises a first sub-partition method and a second sub-partition method, and performing an i-th fold partition in the M-fold region partition on the target region based on the target partition method comprises:
partitioning the target region into at least two sector-shaped sub-regions centered on a target position point according to the first sub-partition method to obtain a first region group, the first region group comprising the at least two sector-shaped sub-regions and a central sub-region, and the central sub-region being the region where the target position point is located;
partitioning the target region into at least two annular sub-regions centered on the target position point according to the second sub-partition method to obtain a second region group, the second region group comprising the at least two annular sub-regions and the central sub-region;
wherein the target position point is a position point of the preset urban entity corresponding to the central node in the target region, an i-th region partition subset comprises the first region group and the second region group, the i-th region partition subset is the region partition subset corresponding to the i-th fold partition among the M region partition subsets, the position parameters of the first sub-partition method are different in the different fold partitions, and the distance parameters of the second sub-partition method are different in the different fold partitions.

9. The data updating method according to claim 8, wherein the updating the node features of the central node based on the target regional features of the sub-regions in the region partition set to obtain the target feature data comprises:
fusing the target regional features of the sub-regions in each first sub-region group respectively to obtain M first feature data, and the M first feature data corresponding one-to-one with the M region partition subsets;
fusing the target regional features of the sub-regions in each second sub-region group respectively to obtain M second feature data, and the M second feature data corresponding one-to-one with the M region partition subsets;
updating the node features of the central node based on the M first feature data and the M second feature data to obtain the target feature data.

10. The data updating method according to claim 9, wherein the fusing the target regional features of the sub-regions in the each first sub-region group respectively to obtain M first feature data comprises:
concatenating the target regional features of the sub-regions within the each first sub-region group respectively to obtain the M first feature data.

11. The data updating method according to claim 9, wherein the fusing the target regional features of the sub-regions in the each second sub-region group respectively to obtain M second feature data comprises:
concatenating the target regional features of the sub-regions within the each first sub-region group respectively to obtain the M first feature data.

12. The data updating method according to claim 9, wherein the updating the node features of the central node based on the M first feature data and the M second feature data to obtain the target feature data comprises:
concatenating the M first feature data to obtain a first updating feature;
concatenating the M second feature data to obtain a second updating feature;
performing weighted summation of the first updating feature and the second updating feature to obtain the target feature data.

13. The data updating method according to claim 1, wherein the generating the regional features of each of the sub-regions based on the feature set comprises:
aggregating the node features corresponding to all nodes located within the same sub-region to obtain the regional features of each of the sub-regions.

14. A model training method, comprising:
obtaining urban graph data, the urban graph data comprising a node set, an edge set, and a feature set, the node set comprising central nodes corresponding to preset urban entities in the preset region, the edge set comprising neighborhoods corresponding to the central nodes, the neighborhoods comprising other nodes in the node set possessing connecting edges with the central nodes, the feature set comprising node features of the central nodes, the neighborhoods corresponding to a target region in the preset region, and the preset urban entities corresponding to the nodes in the neighborhood are located within the target region;
updating the node features of each of the central nodes in the feature set based on the data updating method according to claim 1 to obtain a target feature set, and the target feature set comprising target feature data of each node in the node set;
training a pre-constructed initial urban index generation model based on the node set, the edge set and the target feature set to obtain a target model, wherein the target model is used to generate score values of preset urban indices, and wherein the preset urban indices are urban indices associated with the preset urban entities.

15. An electronic device, comprising:
at least one processor; and
a memory communicatively connected to the at least one processor,
wherein the storage stores therein an instruction configured to be executed by the at least one processor, and the at least one processor is configured to execute the instruction, to implement:
partitioning a target region into at least two sub-regions to obtain a region partition set, wherein the target region corresponds to a neighborhood of a central node, the neighborhood comprises other nodes possessing a connecting edge to the central node, and preset urban entities corresponding to the nodes in the neighborhood are located within the target region;
generating regional features for each of the sub-regions based on node features of the nodes in the neighborhood;
generating a relation set based on the regional features of the sub-regions in the region partition set, wherein the relation set comprises at least two pieces of relation information corresponding to the at least two sub-regions in a one-to-one manner, and the relation information is used to represent relation information between the corresponding sub-region and other sub-regions;
updating the node features of the central node based on the relation set and the regional features of the sub-regions in the region partition set to obtain target feature data.

16. The electronic device according to claim 15, wherein the relation information comprises common information and difference information, the common information is used to represent shared information between the corresponding sub-region and other sub-regions, and the difference information is used to represent difference information between the corresponding sub-region and other sub-regions.

17. The electronic device according to claim 16, wherein when generating the relation set based on the regional features of the sub-regions in the region partition set, the at least one processor is configured to perform:
calculating similarity between regional features of a target sub-region and the regional features of each of the sub-regions in the region partition set to obtain the common information, wherein the common information comprises at least two pieces of similarity information corresponding to the at least two sub-regions in a one-to-one manner, and the target sub-region is any one of the sub-regions in the region partition set.

18. The electronic device according to claim 16, wherein when generating the relation set based on the regional features of the sub-regions in the region partition set, the at least one processor is configured to perform:
calculating the difference degree between the regional features of the target sub-region and the regional features of each of the sub-regions in the region partition set to obtain the difference information, wherein the difference information comprises at least two pieces of difference degree information corresponding to the at least two sub-regions in a one-to-one manner, and the target sub-region is any one of the sub-regions in the region partition set.

19. The electronic device according to claim 16, wherein when updating the node features of the central node based on the relation set and the regional features of the sub-regions in the region partition set to obtain the target feature data, the at least one processor is configured to perform:
updating the regional features of each of the sub-regions based on the relation set to obtain target regional features of each of the sub-regions;
updating the node features of the central node based on the target regional features of the sub-regions in the region partition set to obtain the target feature data.

20. The electronic device according to claim 19, wherein when updating the regional features of each of the sub-regions based on the relation set to obtain the target regional features of each of the sub-regions, the at least one processor is configured to perform:
updating the regional features of each of the sub-regions based on the common information in the relation set to obtain a first feature of each of the sub-regions;
updating the regional features of each of the sub-regions based on the difference information in the relation set to obtain a second feature of each of the sub-regions;
performing weighted summation of the first feature and the second feature for each of the sub-regions to obtain the target regional features of each of the sub-regions.
